(19) United States
(12) Patent Application Publication
(10) Pub. No.: US 2011/0182648 A1
(43) Pub. Date: Jul. 28, 2011

(54) PRINTER

(75) Inventors: Koki SHIMADA, Saitama-shi (JP); Naoki YOSHIDA, Toshima-ku (JP)

(73) Assignee: FUJIFILM CORPORATION, Tokyo (JP)

(21) Appl. No.: 13/009,493

(22) Filed: Jan. 19, 2011

(30) Foreign Application Priority Data
Jan. 28, 2010 (JP) 2010-017105

(51) Int. Cl. B41J 13/02

(52) U.S. Cl. 400/642

(57) ABSTRACT

The present invention provides method capable of easily correcting inclination of a lenticular sheet. When the front end of the lenticular sheet 3 contacts the left receiving pin and is carried further, the lenticular sheet 3 will incline in the anticlockwise direction to contact with the left and right receiving pin. When the lenticular sheet 3 is carried in the sub scanning direction, an adjustment azimuth angle is calculated based on detection signals output from lens sensors. Based on the adjustment azimuth angle, an inclination correction control unit forwardly-rotates motors in a state wherein the connection between a left and right driving shaft is released and rotates the left motor faster than the right motor and the damper rotates in the clockwise direction. The inclination correction control unit rotates the damper in the clockwise direction until the adjustment azimuth angle becomes zero, and then stops the rotations of the motors.

### BACKGROUND OF THE INVENTION

1. Field of the Invention

The present invention relates to a printer which records an image on a lenticular sheet.

2. Description of the Related Art

To observe a three-dimensional image using a lenticular sheet having a plurality of lenticular lenses aligned in a constant pitch is known in the art. In order to observe a three-dimensional image, for example, striped (linear) images which are made by dividing two kinds of images photographed from two viewpoints of left and right having a parallax into stripes respectively, are arranged on the rear face of the lenticular sheet for each lenticular lens. Thereby, by the right and left eyes observing the striped images having a parallax via each lenticular lens, a three-dimensional image can be observed. In addition, to enables a three-dimensional image having a better three-dimensional effect to be observed by taking N images from N viewpoints which are more than three viewpoints, dividing each into stripes, and arranging the striped images for N viewpoints for each lenticular lens is also known in the art.

As a method of arranging striped images on the rear face of a lenticular sheet, although there is known method which preliminarily attaches a printing (hard copy) with all the striped images aligned and recorded onto the rear face of a lenticular sheet, there also is a known method which directly records the images onto the rear face of a lenticular sheet with a printer. When recording the images with a printer, while a lenticular sheet is being carried in the sub scanning direction, a plurality of striped images parallel to the main scanning direction are recorded on the rear face of the lenticular sheet. The recording quality degrades when the longitudinal direction of lenticular lenses is inclined with respect to the main scanning direction. Therefore, various attempts has made to prevent the inclination of the lenticular lenses

In the image recording device as disclosed in Japanese Patent No. 3352879, an emitting unit which emits light toward a lenticular sheet and a receiving unit which receives light from the emitting unit are provided, and based on the change in the amount of light received at the receiving unit when the lenticular sheet is moved in the main scanning direction and the amount of sheet movement, the inclination angle in the longitudinal direction of the lenticular lens with respect to the main scanning direction is detected. Based on the detected inclination angle, to perform the correction of the inclination, a rotating mechanism rotates the lenticular sheet to parallelly align the longitudinal direction of the lenticular lens and the main scanning direction, thereby preventing the degradation of recording quality due to the inclination of the lenticular lens. In addition, the inclination angle is accurately detected by detecting the inclination angle after rotating the lenticular sheet in a specified angle or more using the rotating mechanism.

### SUMMARY OF THE INVENTION

In the image recording device as disclosed in Japanese Patent No. 3352879, although the inclination angle can be detected, detecting the inclination direction is difficult, and there is no description on the method of correcting the inclination direction. Therefore, when a lenticular sheet is rotated in the direction opposite to the inclination direction, inclination correction needs to be performed again, which extends the processing time. Even when the lenticular sheet is rotated by the rotating mechanism in the specified angle or more, although the inclination angle can be precisely detected, detecting the inclination direction is difficult.

Therefore, the present invention aims to solve above-mentioned problem, and the object of the present invention is to provide a printer which can easily perform the inclination correction of a lenticular sheet.

In order to achieve above-mentioned object of the present invention, a printer of the present invention comprises a holding unit which holds a lenticular sheet having a plurality of lenticular lenses aligned in a constant pitch, a carrying unit which carries the lenticular sheet by moving the holding unit in the sub scanning direction, a recording unit which records at least two kinds of images by recording a plurality of striped images parallel to the main scanning direction extending in the direction perpendicularly crossing the sub scanning direction on the rear face of the lenticular sheet carried by the carrying unit, a sheet inclining unit which inclines the lenticular sheet in a first direction or in the direction which the longitudinal direction of the lenticular lenses are inclined with respect to the main scanning direction prior to the holding of the lenticular sheet with the carrying unit, an inclination angle detecting unit which detects the angle of inclination between the longitudinal direction of the lenticular lenses and the main scanning direction in a state wherein the lenticular sheet is held by the holding unit, and an inclination correcting unit which corrects the inclination by rotating the holding unit in a second direction which is the opposite direction to the first direction so that the longitudinal direction of the lenticular lenses becomes parallel to the main scanning direction. Note that, the sheet inclining unit inclines the longitudinal direction of the lenticular lenses on the carrying plane of the lenticular sheet. Moreover, “parallel” here includes cases wherein the longitudinal direction of the lenticular lenses is nearly parallel to the main scanning direction.

In addition, the carrying unit preferably comprises a first belt conveyer having a first belt to which one end in the main scanning direction of the holding unit is attached and a first motor which rotates the first belt, and a second conveyer having a second belt to which the other end in the main scanning direction of the holding unit is attached and a second motor which rotates the second belt, wherein the inclination correcting unit rotates the holding unit in the second direction by controlling the driving of at least one of the first motor and the second motor based on the detection results of the inclination angle detecting unit.

Furthermore, the printer preferably comprises a clutch mechanism which switches between the connected and unconnected states of the first motor and the second motor is provided, wherein the clutch mechanism is switched to the unconnected state when rotating the holding unit in the second direction by the inclination correcting unit.

In addition, the printer preferably comprises a carrying roller which carries the lenticular sheet to the holding unit, and two plates of oblique motion restricting plate which restricts the oblique motion of the lenticular sheet, wherein the plates are arranged on the both sides of the lenticular sheet carried by the carrying roller.

Furthermore, the printer preferably comprises a sliding mechanism which slides at least one of the two pieces of oblique motion restricting plate in the main scanning direction, wherein the sliding mechanism slides at least one of the oblique motion restricting plates in the main scanning direction to position the lenticular sheet in the main scanning direction prior to the holding of the lenticular sheet with the carrying unit.

In addition, it is preferable that the sheet inclining unit comprising two units of receiving unit arranged on the holding unit so as to receive the front end of the lenticular sheet at different positions in the sub scanning direction. Note that, two units of receiving unit can be two receiving pins of different sizes arranged parallelly in the sub scanning direction, or two receiving pins of the same size arranged at different positions in the sub scanning direction for example. Moreover, from the viewpoint of simplification and space-saving of the device configuration, it is preferable that the both receiving pins are arranged on the holding unit.

According to the present invention, since the inclination of the lenticular lenses is corrected prior to the holding of the lenticular sheet with the holding unit in a state where the longitudinal direction of the lenticular lenses is inclined in the first direction or a constant direction with respect to the main scanning direction, there is no need of calculating the inclination direction of the lenticular lenses. Thereby, the inclination correction can be preformed by simply rotating the holding unit in the second direction which is opposite direction to the first direction, thus reducing the processing time in correcting the inclination.

Moreover, by using the first and second motors, and the first and second belts which moves the clamp in the sub scanning direction, the holding unit rotates in the second direction, movement and rotation of the holding unit can be easily performed with a simple configuration.

### BRIEF DESCRIPTION OF THE DRAWINGS

FIG. 1 is an illustrative figure showing a schematic view of an embodiment of the printer according to the present invention.

FIG. 2 is an perspective view showing a lenticular sheet.

FIG. 3 is a plan view showing a lenticular sheet and lens sensors.

FIG. 4A is a side view of an azimuth angle detecting unit, FIG. 4B is an illustrative view of a detected signal output from each lens sensor, and FIG. 4C is an illustrative view of a binarized signal of the detected signal.

FIG. 5 is an exploded perspective view showing a clamp unit.

FIG. 6 is a perspective view showing a lenticular sheet and a clamp unit.

FIGS. 7A-7B are side views showing lenticular sheets and clamp units.

FIG. 8 is a block diagram showing the electrical configuration of a printer.

FIG. 9 is a plan view showing a clamp unit when a lenticular sheet is at a clamp position.

FIG. 10 is a plan view showing a clamp unit in a state wherein a lenticular sheet is inclined in the anticlockwise direction.

FIG. 11 is a plan view showing a clamp unit in a state wherein a lenticular sheet is positioned in the main scanning direction.

FIG. 12 is a plan view showing a clamp unit in a state wherein a lenticular sheet is inclined in the anticlockwise direction.

FIG. 13 is a plan view showing a clamp unit in a state wherein a lenticular sheet is clamped.

FIG. 14 is a plan view showing a clamp unit in a state wherein a clamper with a lenticular sheet clamped is rotated in the clockwise direction.

FIG. 15 a plan view showing a clamp unit in an embodiment wherein a lenticular sheet is inclined by left and right restricting plates.

### DESCRIPTION OF THE PREFERRED EMBODIMENTS

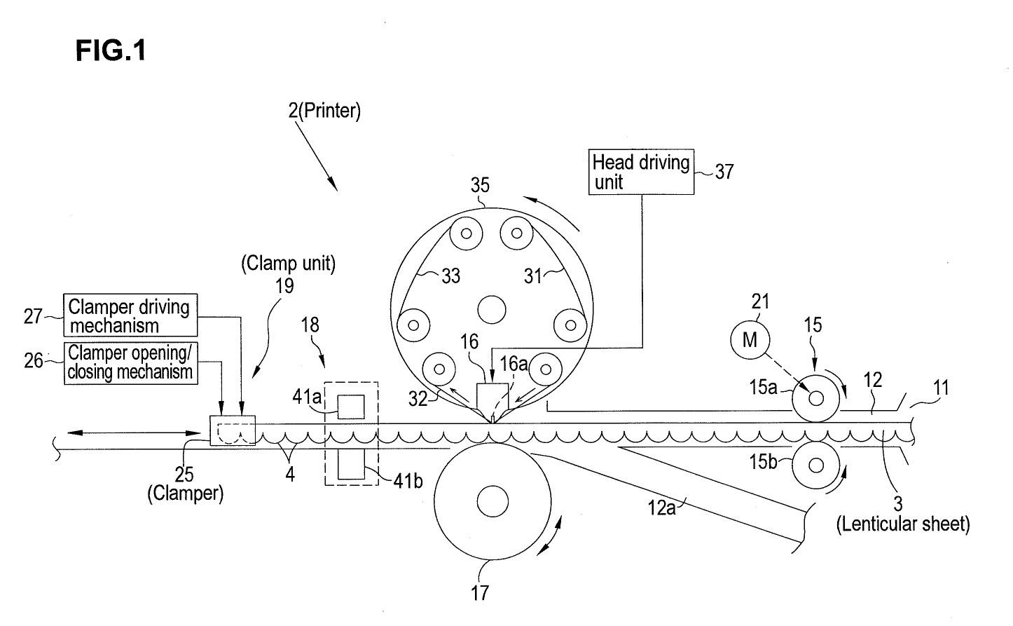

As shown in FIG. 1, a printer 2 records parallax images by a dye sublimation method on the rear face of a lenticular sheet 3 for observing a three-dimensional image. The printer 2 converts parallax images with two viewpoints into parallax images of six viewpoints and records the six-viewpoint parallax images on the lenticular sheet 3.

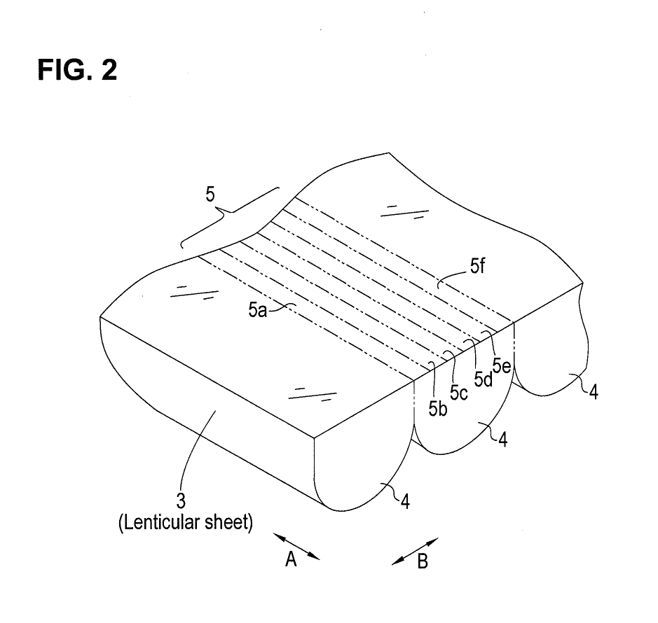

As shown in FIG. 2, the lenticular sheet 3 has a number of hemicylindrical lenticular lenses (hereinafter, simply referred to as “lenses”) 4 aligned on the front face with the rear face having a plane surface as well-known in the art. On the rear face of the lenticular sheet 3, image regions 5 are virtually partitioned by each lens 4, wherein one image region 5 corresponds to one lens 4. Each image region 5 is divided in six into first-sixth minute regions 5a-5f in the direction of the array of lenses 4 corresponding to the number of viewpoints for displaying a three-dimensional image, wherein striped images which are linearly-divided parallax images are individually recorded on each. The minute regions 5a-5f correspond to the parallax images from six viewpoints one-to-one, wherein for example the parallax image from the first viewpoint corresponds to the first minute region 5a, and a striped image generated from the parallax image from the first viewpoint is recorded.

Referring to FIG. 1, the printer 2 is provided with a carrying path 12, through which a lenticular sheet 3 sent into the printer 2 from a carrying port 11 is carried. Inside the carrying path 12, the lenticular sheet 3 is carried along the alignment direction of lenses 4 with the lenses 4 facing downward. Feeding the lenticular sheet 3 into the carrying path 12 may be automatically performed by a feeding mechanism from a cassette wherein the lenticular sheets 3 are accumulated, or the lenticular sheet 3 may be manually inserted into the carrying port 11. Note that, in FIG. 1, the size of the lenses 4 is illustrated exaggeratingly with respect to the actual size of the lenses.

In the downstream side in the sheet carrying direction (hereinafter, simply referred to as the “downstream side”) of the carrying port 11, a pair of feeding rollers 15, a thermal head 16 and a platen roller 17, an azimuth angle detecting unit 18, and a clamp unit 19 are provided in order from the upstream side in the sheet carrying direction (hereinafter, simply referred to as the “upstream side”) along the carrying path 12.

The pair of feeding rollers 15 is composed of a capstan roller 15a and a pinch roller 15b which press-contacts with the capstan roller 15a to pinch the lenticular sheet 3, and carries the lenticular sheet 3 toward the clamp unit 19. The pinch roller 15b moves between a nip position wherein the lenticular sheet 3 is nipped between it and the capstan roller 15a and a nip-release position distanced from the lenticular sheet 3.

The clamp unit 19 comprises a clamper 25 as a holding unit, a clamper opening/closing mechanism 26 and a clamper driving mechanism 27. In the embodiment, the clamper 25 releasably clamps the front end of the lenticular sheet 3. The clamper opening/closing mechanism 26 switches the clamper 25 between a closed state wherein the lenticular sheet 3 is clamped and an open state wherein the clamp is released.

The clamper driving mechanism 27 causes the clamper 25 to reciprocate horizontally along the carrying path 12. Thereby, the lenticular sheet 3 clamped by the clamper 25 reciprocates in the sub scanning direction perpendicular with respect to the main scanning direction. The clamper 25 moves between the clamp position for performing clamping and clamp-releasing of the front end of the lenticular sheet 3 fed by the pair of feeding rollers 15 and the rear end in the downstream side of the clamp position.

Arranged in the carrying path 12 adjacent to the upstream side of the platen roller 17 is a reverse carrying path 12a extending obliquely downwards toward the upstream side. Guided through the reverse carrying path 12a is the lenticular sheet 3 carried to the upstream side by the clamp unit 19. Arranged at an end section of the reverse carrying path 12a is a paper ejection port (not shown) for ejecting the recorded lenticular sheet 3.

The thermal head 16 and the platen roller 17 are positioned so as to hold the carrying path of a recorded film therebetween. Formed on the bottom section of the thermal head 16 is a heat-generating element array 16a wherein a number of heat-generating elements are arranged in lines of two rows in the main scanning direction. By arranging two rows of the heat-generating element array 16a, two lines extending in the main scanning direction can be simultaneously recorded. In addition, by printing two lines of line images in order every time the lenticular sheet 3 is forwarded by two lines, the line images can be recorded next to one another in the sub scanning direction.

The length of each heat-generating element array 16a in the main scanning direction is set a little longer than the width of a recording area (length in the main scanning direction) wherein images should be recorded on the lenticular sheet 3. In addition, by one heat generation of two rows of heat-generating element array 16a, line images are recorded onto one of said minute regions.

In addition, the thermal head 16 moves between a press-contact position wherein a recording film is placed on the rear face of the lenticular sheet 3 on the platen roller 17 and is press-contacted on the rear face, and a retract position wherein it retracts upwards from the press-contact position.

As the recording film, are an image-receiving layer film 31, an ink film 32, and a back layer film 33. The films 31-33 are attached to a film exchanging mechanism 35 placed on the side of the thermal head 16. The film exchanging mechanism 35 has approximately a disk shape, and attached on its perimeter are pairs of spools with the films 31-33 rolled on each. The film exchanging mechanism 35 rotates when the thermal head 16 is in the retract position to move one of the films 31-33 to directly below the thermal head 16.

Every recording film has the same length as the length of the heat-generating element array 16a of the thermal head 16 in the main scanning direction, and a long one is rolled on a spool to allow recording on a plurality of lenticular sheets 3. Each recording film is sent from one spool to the other and rolled there in synchronization with the carrying action of the lenticular sheet 3.

The image-receiving layer film 31 is for forming, on the rear face of the lenticular sheet, an image-receiving layer to which color inks from the ink film 32 adhere. When the image-receiving layer film 31 is heated by the thermal head 16 while placed on the rear face of the lenticular sheet 3, it transfers and forms a transparent image-receiving layer on the rear face of the lenticular sheet 3.

The ink film 32 is a well-known sublimation-type ink film, and arranged on it in its longitudinal direction are many yellow ink regions, magenta ink regions and cyan ink regions in order. When the ink film 32 is heated by the thermal head 16 while placed on the image-receiving layer formed on the lenticular sheet 3, it sublimates yellow, magenta and cyan inks which will adhere onto the image-receiving layer. The amounts of adhered inks vary according to the amount of heat generated by the thermal head 16.

When the back layer film 33 is heated while placed on an image recorded on the lenticular sheet 3, it transfers and forms a white back layer on the rear face of the lenticular sheet 3.

The head driving unit 37 drives the thermal head 16. When forming the image-receiving layer or the back layer, the head driving unit 37 drives the thermal head 16 so that necessary amounts of heat for transferring them are generated simultaneously by the respective heat-generating elements. In addition, when recording an image using the ink film 32, the head driving unit 37 drives the thermal head 16 based on the parallax image data of six viewpoints to record three colors in a frame sequential manner.

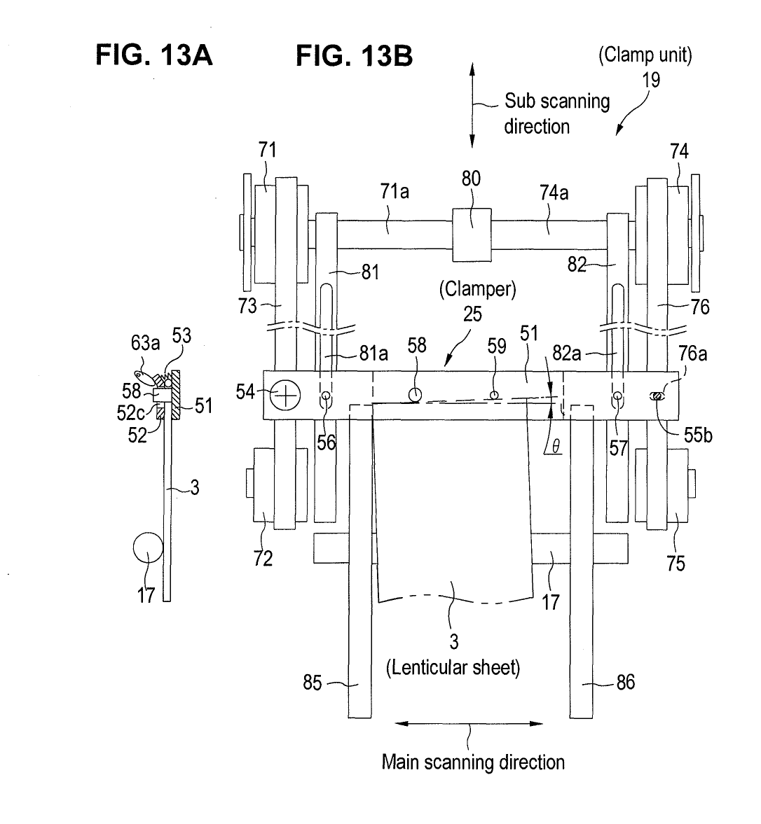

The azimuth angle detecting unit 18 optically detects the lens azimuth angle θ of the lens 4 (hereinafter, simply referred to as the “azimuth angle θ”) on the lenticular sheet 3 carried by the clamp unit 19. The azimuth angle θ is an inclination angle formed by the longitudinal direction of the lens 4 and the main scanning direction (see FIG. 13).

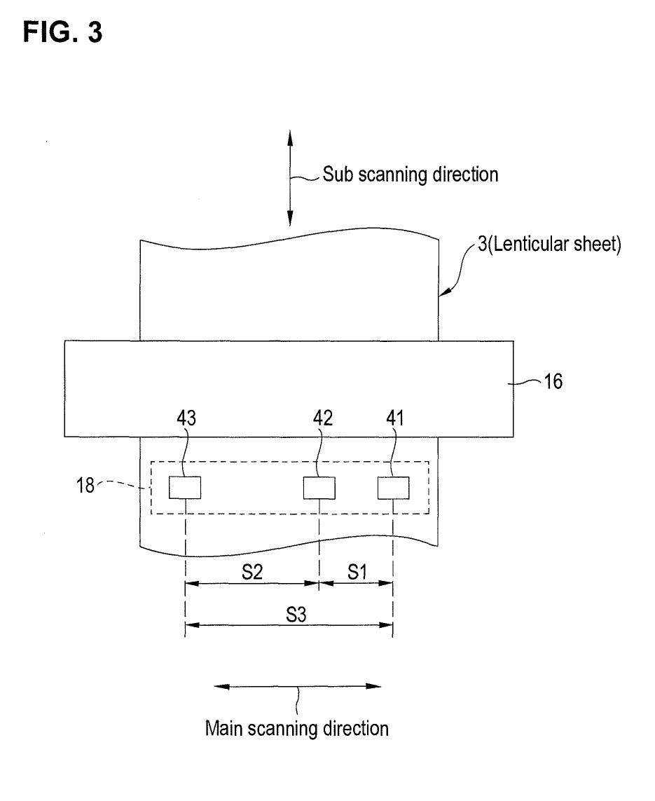

As shown in FIG. 3, the azimuth angle detecting unit 18 comprises first-third lens sensors 41-43 arranged as a row along the main scanning direction. The first lens sensor 41 is arranged in a position opposing one (right side) of the side edges of the lenticular sheet 3. The third lens sensor 43 is arranged in a position opposing the other (left side) of the side edges of the lenticular sheet 3. The second lens sensor 42 is arranged in the first lens sensor 41 side relative to the midpoint of the first lens sensor 41 and the third lens sensor 43. Therefore, the distance S2 between the second lens sensor 42 and the third lens sensor 43 is longer than the distance S1 between the first lens sensor 41 and the second lens sensor 42.

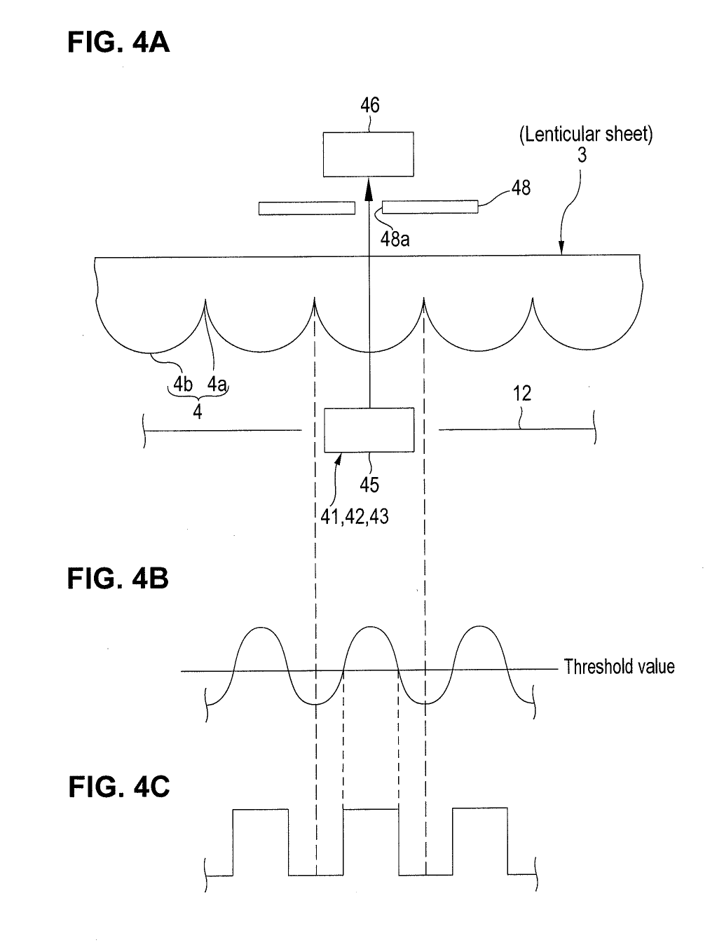

As shown in FIG. 4A, each of the lens sensors 41-43 comprises a light-emitting diode (hereinafter referred to as “LED”) 45 placed below the lenticular sheet 3 and a photosensor 46 placed above the LED 45. The LED 45 emits detection light toward the lenticular sheet 3. The photosensor 46 received the inspection light transmitted by the lenticular sheet 3 and outputs a detection signal according to the strength of the detection light.

In addition, arranged between the LED 45 and the lenticular sheet 3 is a slit plate 48 having a slit 48a which restricts the range of the detection light emitted from the LED 45.

As shown in FIG. 4B, according to the positional relationship between each of the lens sensors 41-43 and the lens 4, the size of the detection light received by the photosensor 46 varies, and the detection signal varies accordingly. The detection signal gradually increases after each of the lens sensors 41-43 faced with a boundary 4a between the lenses 4 until it faces with a peak 4b of the lens 4 for example. Then, the detection signal peaks at the time when each of the lens sensors 41-43 is facing with the peak 4b, gradually decreases afterwards, and starts increasing gradually again when each of the lens sensors 41-43 faces with the boundary 4a.

As shown in FIG. 4C, the detection signal output from each of the lens sensors 41-43 is converted into a binarized signal binarized with a specified threshold value. Based on the binarized signal of each of the lens sensors 41-43, passing of the lens 4 over each of the lens sensors 41-43 is detected.

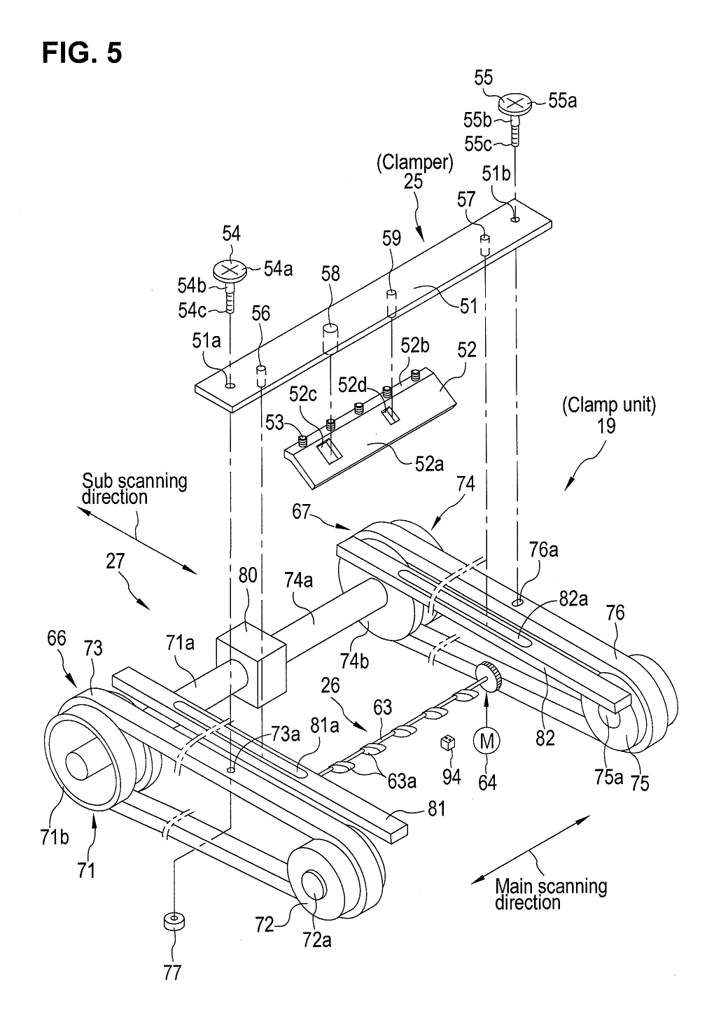

As shown in FIGS. 5-7, the clamper 25 is provided with a fixed plate 51, a movable plate 52 and springs 53. The fixed plate 51 is a flat plate whose length in the main scanning direction becomes about twice the width of the lenticular sheet 3, and is placed in parallel to the carrying plane. Formed on the left-end section of the fixed plate 51 is a left through-aperture 51a for inserting a bolt 54 for attaching the clamper 25. In the same manner, formed on the left-end section of the fixed plate 51 is a right through-aperture 51b for inserting a bolt 55. The bolt 54 or 55 is composed of a head section 54a or 55a, a shaft section 54b or 55b and a threaded screw section 54c or 55c, respectively. Inserted to the through-aperture 51a or 51b is the shaft section 54b or 55b.

The fixed plate 51 has a left guide pin 56 and a right guide pin 57 attached for guiding the clamper 25 in the sub scanning direction. The guide pins 56 and 57 are attached in the outer side of the movable plate 52 and protrude from the bottom face of the fixed plate 51. In addition, the fixed plate 51 has a left receiving pin 58 and a right receiving pin 59 attached for receiving an edge of the lenticular sheet 3. The receiving pins 58 and 59 are attached in the same position in the sub scanning direction, and protrude from the bottom face of the fixed plate 51. The right receiving pin 59 is formed with a smaller diameter than the left receiving pin 58. The pins 56-59 may be formed in one unit with the fixed plate 51.

The movable plate 52 comprises a holding unit 52a which holds between the lenticular sheet 3 with the fixed plate 51 and a receiving unit 52b receiving the springs 53, its length in the main scanning direction is longer than that of the lenticular sheet 3 and shorter than the fixed plate 51, and its cross section is formed in a “V” shape. The movable plate 52 is attached in a rotationally movable manner on the bottom face of the fixed plate 51 via a shaft 61. The holding unit 52a has a left through-aperture 52c to which the left receiving pin 58 is inserted and a right through-aperture 52d to which the right receiving pin 59 is inserted.

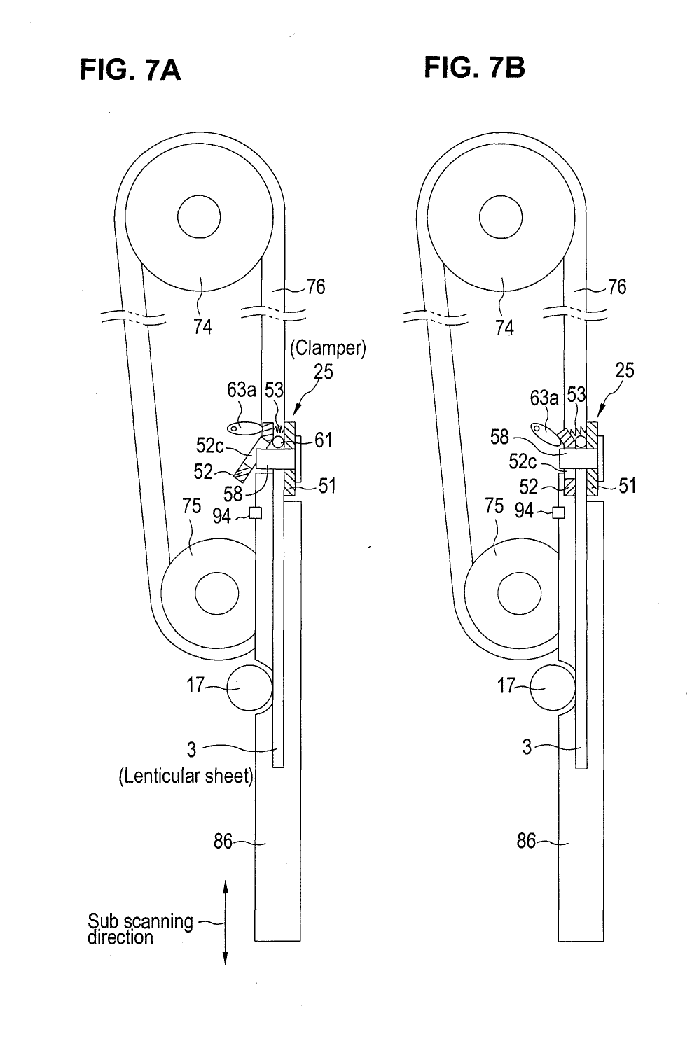

The movable plate 52 rotationally moves between a hold position (see FIG. 7B) wherein the lenticular sheet 3 is held between the holding unit 52a and the fixed plate 51 and a hold-release position (see FIG. 7A) wherein the holding is released. One end of the springs 53 is fixed to the top face of the receiving unit 52b, and the other end of the springs 53 is fixed to the bottom face of the fixed plate 51. With these springs 53, the movable plate 52 is biased toward the hold position. Five pieces of springs 53 are arranged. Arranged on the bottom face of the fixed plate 51 and the top face of the holding unit 52a is an anti-slip member (not shown) for clamping the lenticular sheet 3 without slipping.

The clamper opening/closing mechanism 26 comprises a cam shaft 63 which rotationally moves the movable plate 52, a clamp releasing motor 64 which rotates the cam shaft 63, and the springs 53. The cam shaft 63 is placed adjacent to the clamper 25 in the clamp position. The cam shaft 63 has five cams 63a arranged, and these cams 63a come into contact with the bottom face of the receiving unit 52b when the clamper 25 is in the clamp position. The cam shaft 63 rotationally moves between a position wherein the movable plate 52 is rotationally moved to the hold-release position by pressing up the receiving unit 52b with the cam 63a against the bias of the springs 53 by the clamp releasing motor 64 (see FIG. 7A) and a position wherein the movable plate 52 is rotationally moved to the hold position by the bias of the springs 53 by releasing the pressing up of the receiving unit 52b (see FIG. 7B).

The clamper driving mechanism 27 is provided with a left belt conveyer 66 and a right belt conveyer 67 which move the clamper 25 in the sub scanning direction. The left belt conveyer 66 is provided with a left motor 71, a left pulley 72, and a left belt 73 wrapped around the left motor 71 and the left pulley 72. In the same manner, the right belt conveyer 67 is provided with a right motor 74, a right pulley 75, and a right belt 76. The pulleys 72 and 75 are attached to rotation shafts 72a and 75a which are arranged in a rotatable manner.

Formed on the left belt 73 is a through-aperture 73a to which the bolt 54 is inserted, and formed on the right belt 76 is a through-aperture 76a of an elongated aperture shape which extends laterally and to which the bolt 55 is inserted. The shaft sections 54b and 55b are inserted to the through-apertures 73a and 76a, respectively, and the screw sections 54c and 55c protrude slightly out of the bottom face of the belts 73 and 76, respectively. Thereby, if nuts 77 are fixed to the screw sections 54c and 55c, the clamper 25 is attached in a rotatable manner to the belts 73 and 76.

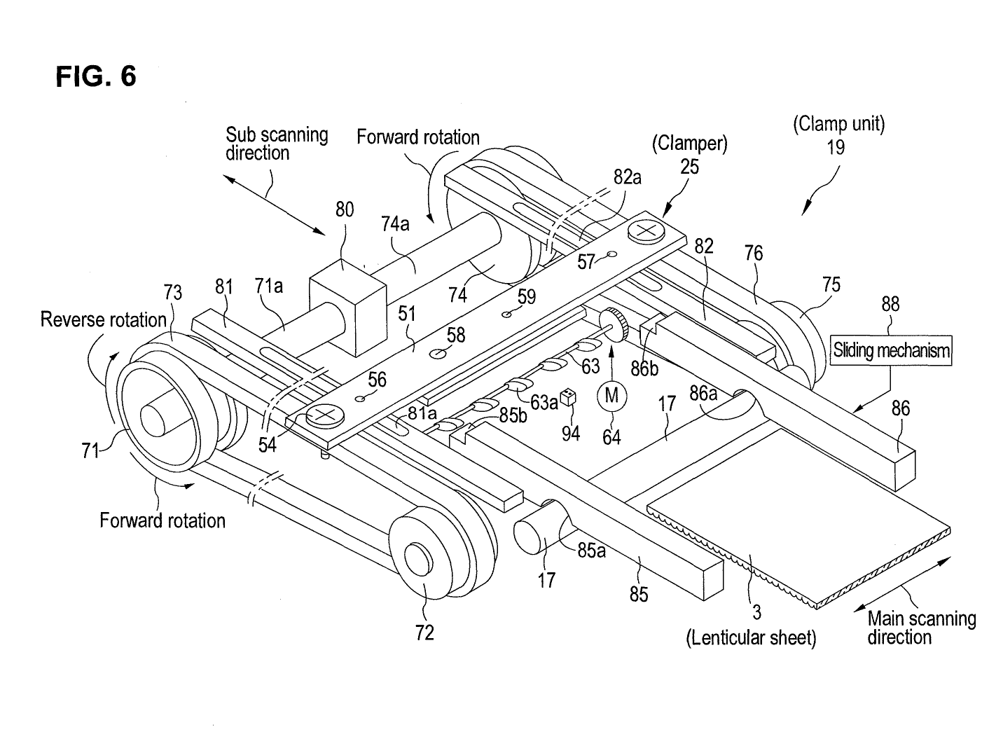

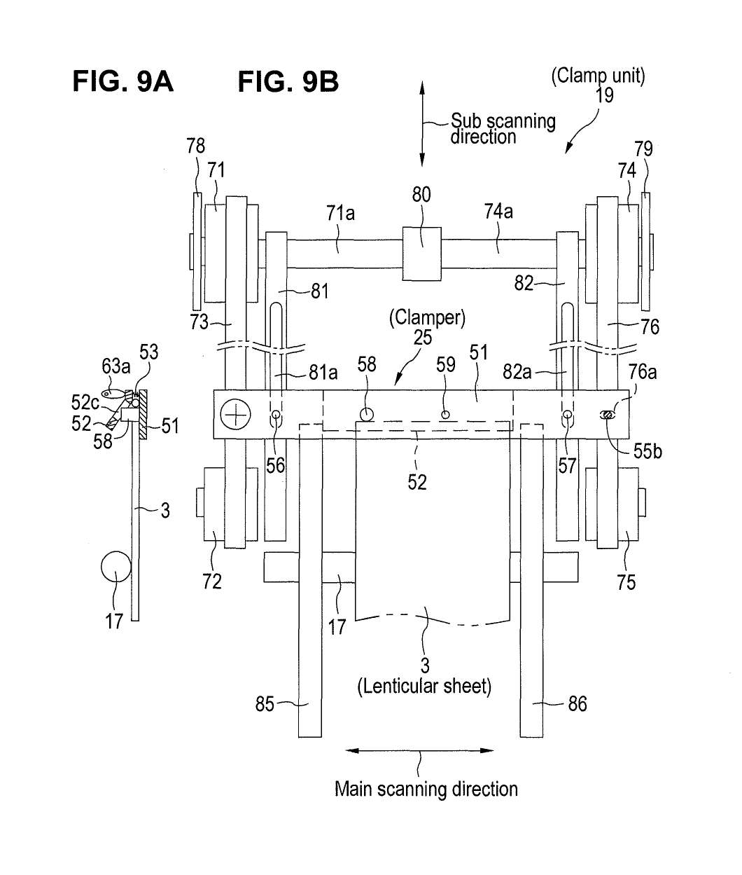

The left motor 71 is composed of a left driving shaft 71a and a main body unit 71b which is fixed to the left driving shaft 71a and formed in a pulley shape so that the left belt 73 can be wrapped around it. The left driving shaft 71a is attached to a motor plate 78 (see FIG. 9) in a rotatable manner, and the left driving shaft 71a and the main body unit 71b rotate together. In the same manner, the right motor 74 comprises a right driving shaft 74a and a main body unit 74b, and the right driving shaft 74a is attached to a motor plate 79 (see FIG. 9) in a rotatable manner. Attached on each of the motor plates 78 and 79 are a motor control circuit board with a driving circuit and a coil arranged to drive the motor 71 or 74, and a bearing (not shown) which supports the driving shaft 71a or 74a in a rotatable manner. In FIGS. 5 and 6, the motor plates 78 and 79 are omitted.

The left driving shaft 71a and the right driving shaft 74a can be switched by a clutch mechanism 80 between a connected state and a released state.

The clamper driving mechanism 27 is provided with a left guide rail 81 and a right guide rail 82 which guide the clamper 25 in the sub scanning direction. Formed on the guide rails 81 and 82 are a left guide aperture 81a and a right guide aperture 82a of an elongated aperture shape to which the guide pins 56 and 57 are inserted. The guide apertures 81a and 82a are formed with a larger diameter than that of the guide pins 56 and 57.

Placed on the inner side of the left guide rail 81 and the right guide rail 82 are a left oblique motion restricting plate 85 and a right oblique motion restricting plate 86 which restrict the oblique movement of the lenticular sheet 3. The left oblique motion restriction plate 85 has a cut-out 85a formed on almost the center of the bottom face to which the platen roller 17 is inserted, and a concave section 85b formed on the front end of the top face for entering below the fixed plate 51 of the damper 25. In the same manner, a cut-out 86a and a concave section 86b are formed on the right oblique motion restricting plate 86.

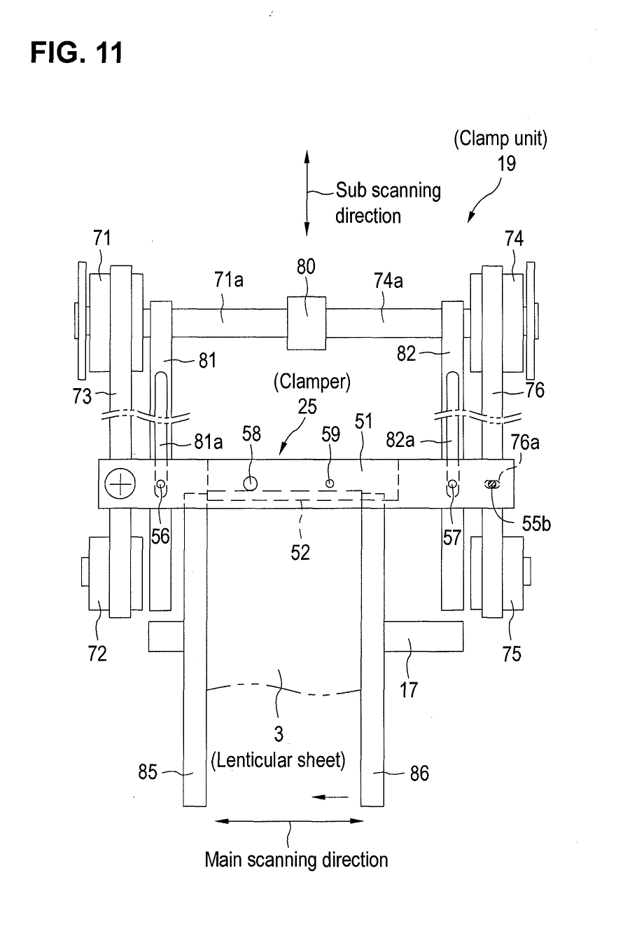

The right oblique motion restricting plate 86 is arranged slidable in the main scanning direction and slides by a sliding mechanism 88 between a base position wherein the distance to the left oblique motion restricting plate 85 is wider than that of the lenticular sheet 3 (see FIGS. 6 and 9) and a press position wherein the lenticular sheet 3 is positioned by pressing it against the left oblique motion restricting plate 85 (see FIG. 11). The right oblique motion restricting plate 86 is ordinarily in the base position. The left oblique motion restricting plate 85 may be arranged slidable, and further both the left oblique motion restricting plate 85 and the right oblique motion restricting plate 86 may be arranged slidable.

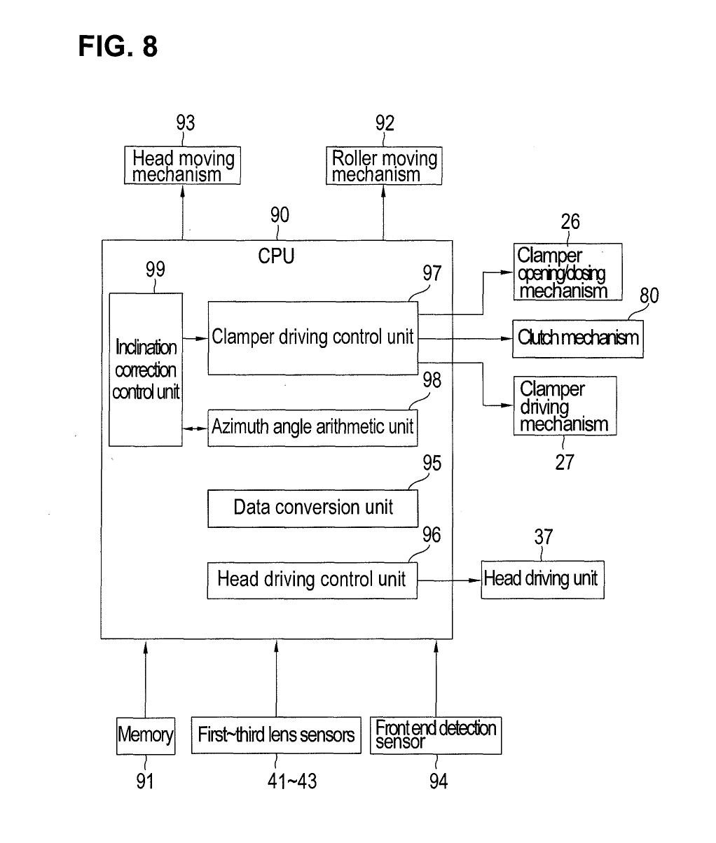

As shown in FIG. 8, a CPU 90 will overall control each section of the printer 2. The CPU 90 is connected with the clamper opening/closing mechanism 26, the clamper driving mechanism 27, the head driving unit 37, and the first-third lens sensors 41-43 as mentioned above, and furthermore, is connected with a memory 91, a roller moving mechanism 92, a head moving mechanism, a front end detection sensor 94 and the like. The motors 21, 64, 71 and 72 are connected to the CPU 90 via motor derivers not shown.

Various kinds of programs and data for controlling the printer 2 are stored in the memory 91. The CPU 90 controls the printer 2 by reading these programs and data from the memory 91 and sequentially processing them. In addition, a RAM area of the memory 91 functions as a work memory for the CPU 90 to execute processes and a temporary storage of various kinds of data.

A roller moving mechanism 92 moves the pinch roller 15b to the nip position or the nip-release position according to the control signal from the CPU 90. A head moving mechanism 93 moves the thermal head 16 to the press-contact position or the retract position according to the control signal from the CPU 90.

A front end detection sensor 94 is arranged adjacent to the upstream side of the clamp position (see FIG. 6). The front end detection sensor 94 is an optical sensor similar to the lens sensors 41-43, and when having detected the passing of an edge of the lenticular sheet 3, it outputs a detection signal indicating such to the CPU 90.

By sequentially executing programs read out from the memory 91, the CPU 90 functions as a data conversion unit 95, a head driving control unit 96, a clamper driving control unit 97, an azimuth angle arithmetic unit 98, and an inclination correction control unit 99 for example.

The data conversion unit 95 reads out parallax image data of two viewpoints stored in the memory 91 and converts these parallax images into image data of six viewpoints through an image processing. The head driving control unit 96 controls the driving of the thermal head 16 by the head driving unit 37.

The clamper driving control unit 97 controls the switching between the open/close states of the clamper 25 by the clamper opening/closing mechanism 26. In addition, the clamper driving control unit 97 controls the movement of the clamper 25 in the sub scanning direction by the clamper driving mechanism 27 and the rotation of the clamper 25.

Based on the results of an arithmetic operation by the azimuth angle arithmetic unit 98, the inclination correction control unit 99 performs inclination correction control which allows the clamper driving control unit 97 to execute rotation of the clamper 25 so that the longitudinal direction of the lenses 4 becomes parallel to the main scanning direction. The inclination correction control unit 99 accomplishes inclination correction control of the lenses 4 through two stages of a coarse adjustment control and a fine adjustment control.

The coarse adjustment control obtains the azimuth angle (hereinafter referred to as the “coarse adjustment azimuth angle”) by the azimuth angle arithmetic unit 98 based on binarized signals from the first and second lens sensors 41 and 42 and the distance S1 (see FIG. 3) and corrects the inclination of the lenses 4 based on the coarse adjustment azimuth angle. The fine adjustment control unit obtains the azimuth angle (hereinafter referred to as the “fine adjustment azimuth angle”) by the azimuth angle arithmetic unit 98 based on binarized signals from the first and third lens sensors 42 and 43 and the distance S3 between the both lens sensors 41 and 43 (see FIG. 3) and corrects the inclination of the lenses 4 based on the fine adjustment azimuth angle.

Other than functioning as above-mentioned individual units, the CPU 90 has functions such as a conversion function to convert detection signals output from the first-third lens sensors 41-43 into binarized signals and a detection function to detect the positional relationship among the lenticular sheet 3, the clamper 25, and the heat-generating element array 16a.

The positional relationship between the lenticular sheet 3 and the clamper 25 is obtained based on the amount by which the lenticular sheet 3 was carried since a detection signal was input from the front end detection sensor 94. In addition, the positional relationship between the lenticular sheet 3 and the heat-generating element array 16a is obtained based on the amount by which the lenticular sheet 3 was carried since a stand-up timing of the binarized signal, the known positional relationship between the lens sensors and the lenses 4 in the sub scanning direction at the stand-up time of the binarized signal, the known distance between the azimuth angle detecting unit 18 and the heat-generating element array 16a, the pitch of the binarized signals, and the like.

Hereinafter, the mode of actions of the printer 2 having above-mentioned configuration are explained with referring to the drawings of FIGS. 9-14. First, parallax image data of two viewpoints of an image to be recorded are input to an input I/F (not shown) of the printer 2. These input parallax image data of two viewpoints are temporarily stored in the memory 91. The data conversion unit 95 of the CPU 90 reads out the parallax image data of two viewpoints from the memory 91, converts these parallax image data to parallax image data of six viewpoints, and stores them again in the memory 91.

Once a recording start operation is performed, the CPU 90 confirms that the thermal head 16 is in the retract position. In addition, based on the detection results of a rotational position detection sensor (such as a rotary encoder, not shown) of the clamper 25, the clamper driving control unit 97 of the CPU 90 controls the clamper driving mechanism 27 (controls the rotations of the left motor 71 and the right motor 74) so that the clamper 25 becomes approximately parallel to the main scanning direction. Next, the clamper driving control unit 97 rotates the motors 71 and 74 to move the clamper 25 to the clamp position. After moving the clamper 25, the clamper driving control unit 97 controls the clamper opening/closing mechanism 26 to switch the clamper 25 to the open state.

After the clamper 25 is switched to the open state, one piece of lenticular sheet 3 is fed into the carrying path 12 through the carrying port 11. When carrying is detected by a carrying detection sensor (not shown), the CPU 90 rotates a motor 21. Thereby, the lenticular sheet 3 is held with the pair of feeding rollers 15, and by the pair of feeding rollers 15 the lenticular sheet 3 is fed toward the downstream side of the carrying path 12. The lenticular sheet 3 passes between the thermal head 16 in the retract position and the platen roller 17 in a state wherein oblique movement is restricted by the left oblique motion restricting plate 85 and the right oblique motion restricting plate 86, further passes the azimuth angle detecting unit 18, and its front end reaches the vicinity of the clamper 25 and is detected by the front end detection sensor 94.

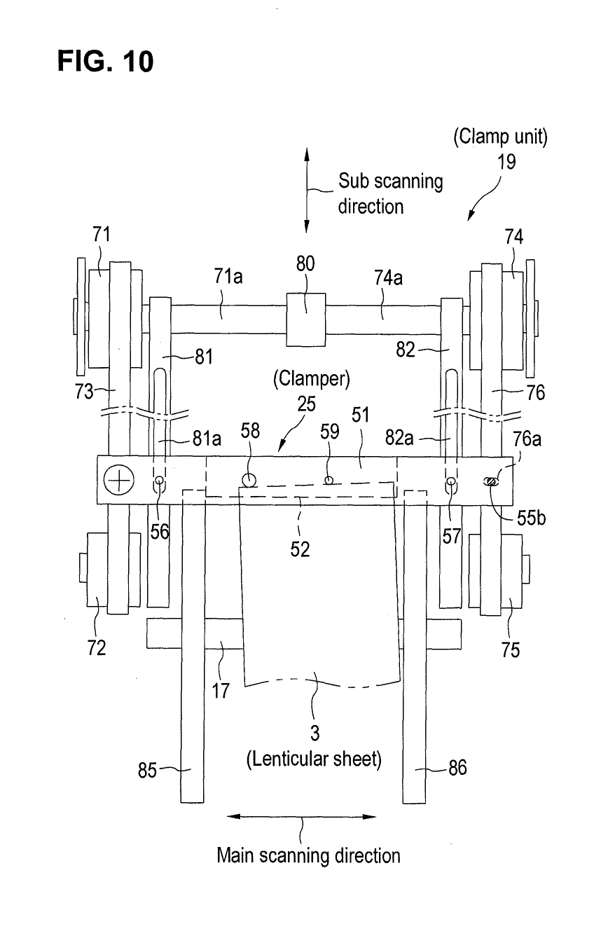

When the front end of the lenticular sheet 3 is detected by the front end detection sensor 94, the CPU 90 further performs carrying over a specified length by the pair of feeding rollers 15, and as shown in FIG. 9, has the front end of the lenticular sheet 3 contact the left receiving pin 58. The CPU 90 performs carrying by the pair of feeding rollers 15 for a specified time (three seconds for example) from this state. By the carrying, as shown in FIG. 10, the lenticular sheet 3 rotates in the anticlockwise direction centering on the part in contact with the left receiving pin to be inclined, and its front end contacts the right receiving pin 59. After the passage of three seconds, the CPU 90 stops the rotation of the motor 21 and stops carrying. Omitted in FIG. 9A are members other than the lenticular sheet 3, the platen roller 17, the clamper 25, and the cam 63a. In addition, the inclination of the lenticular sheet 3 is illustrated exaggeratingly in FIG. 10.

As shown in FIG. 11, after the stoppage of carrying the lenticular sheet 3, the CPU 90 has the right oblique motion restricting plate 86 slide leftwards from the base position to the press position by the sliding mechanism 88, presses the lenticular sheet 3 against the left oblique motion restricting plate 85 to perform positioning in the main scanning direction, and return the right oblique motion restricting plate 86 to the base position.

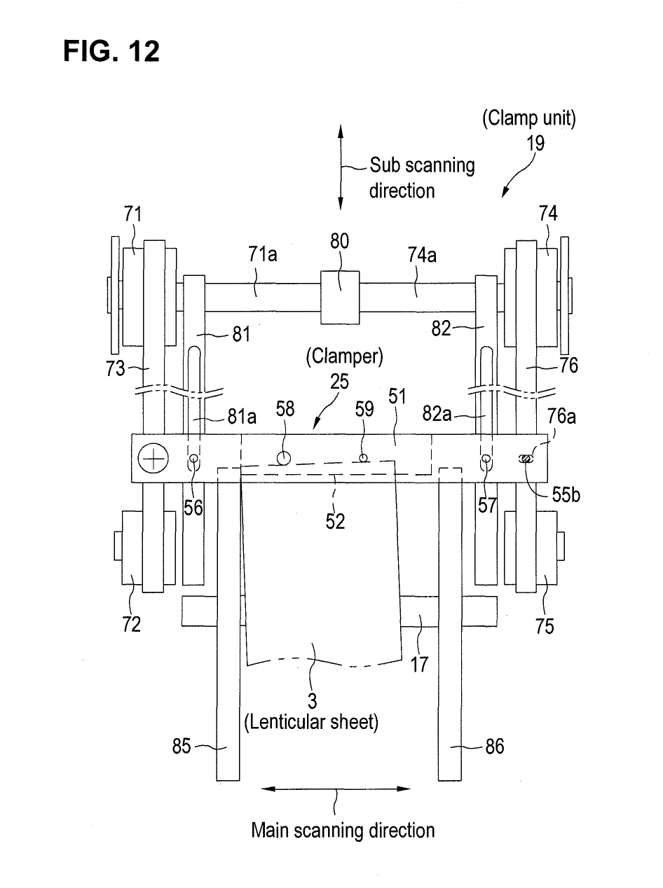

Once the lenticular sheet is pressed against the left oblique motion restricting plate 85 to perform positioning in the main scanning direction, since the inclination of the lenticular sheet 3 is also corrected, the CPU 90 rotates the motor 21 again for a specified time (three seconds for example) to perform carrying with the pair of feeding rollers 15. By the carrying, as shown in FIG. 12, the lenticular sheet 3 rotates in the anticlockwise direction to be inclined, and its front end contacts the right receiving pin 59. After the passage of three seconds, the rotation of the motor 21 is stopped, and carrying is stopped. In FIG. 12, the inclination of the lenticular sheet is illustrated exaggeratingly.

As shown in FIG. 13, after the stoppage of carrying the lenticular sheet 3, the clamper driving control unit 97 rotates the clamp releasing motor 64 to rotationally move the cam shaft 63, thereby releasing the pressing-up of the receiving unit 52b by the cam 63a. Thereby, the movable plate 52 is rotationally moved to the holding position by the bias of the springs 53, and the front end of the lenticular sheet 3 is clamped by the clamper 25. After clamping, the CPU 90 controls the roller moving mechanism 92 to release the nipping of the lenticular sheet 3 by the pair of feeding rollers 15.

Next, the clamper driving control unit 97 moves the clamper 25 toward the downstream side by forwardly-rotating the left motor 71 and the right motor 74 at the same speed in a state wherein the connection between the left driving shaft 71a and the right driving shaft 74a is released by the clutch mechanism 80. Thereby, carrying the lenticular sheet 3 in the sub scanning direction is started. Once the carrying of the lenticular sheet 3 in the sub scanning direction is started, based on the binarized signals of detection signals output from the first-third lens sensors 41-43, the inclination correction control of the lens 4 is started. Based on the binarized signals from the first and second lens sensors 41 and 42, the azimuth angle arithmetic unit 98 calculates the coarse adjustment azimuth angle and inputs the angle to the inclination correction control unit 99.

Once the coarse adjustment azimuth angle is input, the inclination correction control unit 99 controls the clamper driving control unit 97 to forwardly-rotate the left motor 71 and the right motor 74, wherein the left motor 71 is forwardly-rotated at a higher speed than the right motor 74 (a phase difference is generated between the motors 71 and 74).

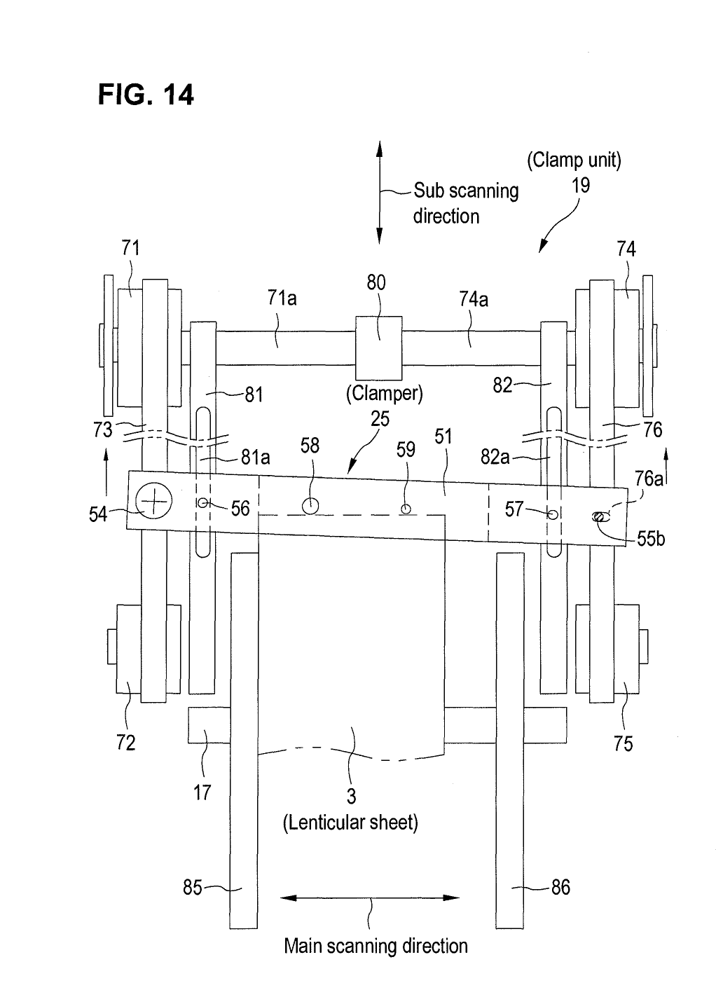

Along with forwardly-rotating the motors 71 and 74, if the left motor 71 is forwardly-rotated at a higher speed than the right motor 74, as shown in FIG. 14, the clamper 25 moves toward the downstream side (upwards in FIG. 14), the lenticular sheet clamped by the clamper 25 is also carried toward the downstream side, and further the left end section of the clamper 25 moves faster than the right end section toward the downstream side. By such movement, the clamper 25 and the lenticular sheet 3 rotate in the clockwise direction. The inclination correction control unit 99 rotates the clamper 25 in the anticlockwise direction until the coarse adjustment azimuth angle becomes zero, and then stops the rotations of the motors 71 and 74. Thereby, the inclination of the longitudinal direction of the lenses 4 relative to the main scanning direction is coarse-adjusted.

The clamper 25 rotates centering on the bolt 54 attached to the left belt 73. Since the INS 56 and 57 arranged on the clamper 25 have smaller diameters than those of the apertures 81a and 82a to which these pins 56 and 57 are inserted, rotation of the clamper 25 becomes possible. In addition, since the through-aperture 76a to which the shaft section 55b of the bolt 55 is inserted is formed in an elongated aperture shape, when the clamper 25 rotates, the shaft section 55b moves laterally (leftwards) in the through-aperture 76a. Thereby, even when the clamper 25 rotates, the right belt 76 is not twisted. In FIG. 4, the inclination of the clamper 25 is illustrated exaggeratingly.

After the coarse adjustment is complete, the clamper driving control unit 97 forwardly-rotates the motors 71 and 74 at the same speed to carry the clamper 25 toward the downstream side in the sub scanning direction. Note that, in doing so, if the rear end of the lenticular sheet 3 passes the azimuth angle detecting unit 18, the clamper 25 is once carried toward the upstream side by reversely-rotating the motors 71 and 74, and it is then carried toward the downstream side again.

Next, based on the binarized signals from the first and third lens sensors 41 and 43, the azimuth angle arithmetic unit 98 calculates the fine adjustment azimuth angle and inputs the angle to the inclination correction control unit 99.

In the same way as in the coarse adjustment, the inclination correction control unit 99 rotates the clamper 25 in the clockwise direction until the fine adjustment azimuth angle become zero and stops the rotations of the motors 71 and 74. Thereby, the inclination of the longitudinal direction of the lenses 4 relative to the main scanning direction is fine-adjusted. Since the lenticular sheet 3 is inclined in a constant direction (anticlockwise direction), there is no need to calculate the direction of inclination. Thereby, since the inclination correction can be performed by only rotating the clamper 25 in a constant direction (clockwise direction), the processing time for the inclination correction is reduced.

After above-mentioned fine adjustment is completed, the clamper driving control unit 97 forwardly-rotates the motors 71 and 74 at the same speed to carry the clamper 25 toward the downstream side (the upstream direction may also do) in the sub scanning direction. The inclination correction control unit 99 compares the binarized signals from the first-third lens sensors 41-43, and if the amount of shift in the stand-up is below a specified amount, the inclination correction is terminated. In addition, if the amount of shift exceeds a specified amount, above-mentioned coarse adjustment and fine adjustment are executed again.

After the inclination correction is complete, the clamper driving control unit 97 reversely-rotates the left motor 71 and the right motor 74 at the same speed to carry the lenticular sheet 3 toward the upstream side.

When carrying the lenticular sheet 3 after completing the inclination correction, the rear end of the lenticular sheet 3 may be once carried to the downstream side of the azimuth angle detecting unit 18, and the lenticular sheet 3 may be carried toward the upstream side. Thereby, the positional relationship between the lenticular sheet 3 and the heat-generating element array 16a is detected by the CPU 90 based on the amount of carrying the lenticular sheet 3 since the stand-up timings of the binarized signals at the lens sensors 41-43, the known positional relationship between the lens sensors and the lens 4 in the sub scanning direction at the stand-up times of the binarized signals, the known distance between the azimuth angle detecting unit 18 and the heat-generating element array 16a, the pitch of binarized signals for example.

In addition, when the inclination correction is completed, one pitch of the binarized signals from the lens sensors 41-43 becomes equal to one lens pitch of the lenses 4. Thereby, the lens pitch is obtained.

When the front end of the recording area of the lenticular sheet 3 has passed the position of the thermal head 16, the clamper driving control unit 97 stops the rotation of the motors 71 and 74 to stop carrying the lenticular sheet 3.

Next, the CPU 90 operates the film exchanging mechanism 35 to set the image-receiving layer film 31 directly under the thermal head 16 and controls the head moving mechanism 93 to move the thermal head 16 to the press-contact position. Thereby, the thermal head 16 press-contacts the rear face of the lenticular sheet 3, sandwiching the image-receiving layer film 31.

After press-contacting by the thermal head 16, the clamper driving control unit 97 forwardly-rotates the left motor 71 and the right motor 74 at the same speed to move the clamper 25 toward the downstream side. Thereby, carrying the lenticular sheet 3 in the sub scanning direction is started, and the image-receiving layer film 31 is forwarded accordingly.

The head driving control unit 96 controls the head driving unit 37 to have the heat-generating element array 16a of the thermal head 16 generate heat, heating the image-receiving layer film 31. Thereby, a transparent image-receiving layer is transferred onto and formed on the rear face of the lenticular sheet 3. The same control is performed until an image-receiving layer is formed over the whole range of the recording area.

Once forming the image-receiving layer is complete, the CPU 90 controls the head moving mechanism 93 to move the thermal head 16 to the retract position. After the thermal head 16 moved, the clamper driving control unit 97 reversely-rotates the left motor 71 and the right motor 74 to carry the lenticular sheet 3 toward the upstream side.

When the front end of the recording area of the lenticular sheet 3 has passed the position of the thermal head 16, the clamper driving control unit 97 stops the rotation of the motors 71 and 74 to stop carrying the lenticular sheet 3. Next, the CPU 90 operates the film exchanging mechanism 35 to set the ink film 32 directly under the thermal head 16 and controls the head moving mechanism to move the thermal head 16 to the press-contact position. At the time, the yellow ink region of the ink film 32 is placed over the rear face of the lenticular sheet 3.

After press-contacting of the thermal head 16, the clamper driving control unit 97 forwardly-rotates the motors 71 and 74 to carry the lenticular sheet 3 toward the downstream side. Moreover, at the time, the CPU 90 continues monitoring the positional relationship between the lenticular sheet 3 and the heat-generating element array 16a. Then, when the heat-generating element array 16a is positioned in the first minute region 5a, the head driving control unit 96 reads out two lines of yellow images to be recorded from the memory 91, sends them to the head driving unit 37 and instructs the head driving unit 37 to record yellow images.

Upon receiving an image recording instruction from the head driving control unit 96, the head driving unit 37 drives the thermal head 16 based on the two lines of yellow image data to have two rows of the heat-generating element array 16a generate head, heating the ink film 32. Thereby, yellow ink sublimated from the ink film 32 adhere onto the image-receiving layer of the first minute region 5a. As a result, two lines of yellow string images are recorded in the first minute region 5a.

After recording an image into the first minute region 5a, the clamper driving control unit 97 forwardly-rotates the motors 71 and 74 to carry the lenticular sheet 3 toward the downstream side by the carrying length equivalent to ⅙ of the lens pitch obtained earlier. After carrying, the head driving control unit 96 reads out the next two lines of yellow image data, sends them to the head driving unit 37, and instructs the head driving unit 37 to record the yellow images. Based on the next two lines of yellow image data, the head driving unit 37 has two rows of the heat-generating element array 16a generate heat to record the two lines of yellow string images in the second minute region 5b.

Hereinafter, in the same manner, every time the lenticular sheet 3 is carried by the carrying length equivalent to ⅙ of the lens pitch, based on two lines of yellow image data, two rows of the heat-generating element array 16a generate heat at a time to record yellow string images in the minute regions 5c-5f in order.

Once the final string images of yellow images are recorded, the clamper driving control unit 97 stops the rotation of the motors 71 and 74 and has the clamper 25 stop carrying the lenticular sheet 3. Next, the CPU 90 controls the heat moving mechanism 93 to move the thermal head 16 to the retract position. Afterward, the clamper driving control unit 97 reversely-rotates the motors 71 and 74 to carry the lenticular sheet 3 toward the upstream side, and when the front end of the recording area has passed the position of the thermal head 16, stops the rotations of the motors 71 and 74 to stop the carrying.

Next, the CPU 90 operates the film exchanging mechanism 35 to forward the ink film 32 to set its magenta ink region directly under the thermal head 16. Then the CPU 90 controls the head moving mechanism 93 to move the thermal head 16 to the press-contact position. Hereinafter, in the same manner as in the yellow image recording, while the lenticular sheet 3 is being carried toward the downstream side, the thermal head 16 is driven based on the magenta image data to record the magenta string images sequentially in the minute regions 5a-5f on the lenticular sheet 3.

After completing recording the magenta images, in a similar procedure to the above, the lenticular sheet 3 is once carried toward the upstream side, and then carried toward the downstream side again. In addition, after forwarding the ink film 32 so as to allow placing the cyan ink region on the rear face of the lenticular sheet 3, the thermal head 16 is moved to the press-contact position. Then, while the lenticular sheet 3 is being carried toward the downstream side, the thermal head 16 is driven based on the cyan image data to record the cyan string images sequentially.

In recording the magenta images and the cyan images also, the recording start timing is controlled in the same manner as in recording the yellow images, and every time the lenticular sheet 3 is carried by the carrying length equivalent to ⅙ of the lens pitch, a string image is recorded.

After three-color images are recorded in the recording area, in the same manner as mentioned above, after the lenticular sheet 3 is once carried toward the upstream side, it is carried toward the downstream side again. In addition, after the back layer film 33 is moved by the film exchanging mechanism 35 to the position of its use, the thermal head 16 is moved to the press-contact position. Then, while the lenticular sheet 3 is being carried toward the downstream side, the thermal head 16 is driven to form a back layer in the recording area wherein the three-color images are recorded.

After forming the back layer, the CPU 90 controls the head moving mechanism 93 to move the thermal head 16 to the retract position. Next, the clamper driving control unit 97 controls the clamper driving mechanism 27 to move the clamper 25 to the clamp position and send the lenticular sheet 3 into the reverse carrying path 12a. After the movement, the clamper driving control unit 97 controls the clamper opening/closing mechanism 26 to switch the clamper 25 to the open state. Thereby, the clamp at the front end of the lenticular sheet 3 is released, and the lenticular sheet 3 is ejected from the ejection port. When printing other lenticular sheets 3, above-mentioned process is repeatedly performed.

In addition, arranged in the printer 2 is a sensor (not shown) which detects a sheet jam, and according to the sheet jam detection by the sensor, the clamper driving control unit 97 reversely-rotates one of the left motor 71 and the right motor 74 in a state wherein the left driving shaft 71a and the right driving shaft 74a are connected by the clutch mechanism 80. In this case, since the motors 71 and 74 are rotated in a synchronized state, the jammed lenticular sheet 3 is also carried securely to the upstream side. Then, after sending the lenticular sheet 3 into the reverse carrying path 12a, clamping by the clamper 25 is released to eject the sheet to the ejection port, which resolves the sheet jam.

Although in the above-mentioned embodiment the clamper is rotated in the clockwise direction while carrying the lenticular sheet in the sub scanning direction by forwardly-rotating the left and right motors and rotating the left motor at a higher speed than the right motor, the clamper may be rotated in the clockwise direction without carrying the lenticular sheet in the sub scanning direction by forwardly-rotating only the left motor. In addition, the clamper may be rotated in the clockwise direction by reversely-rotating the left and right motors and reversely-rotating the right motor at a higher speed than the left motor, or the clamper may be rotated in the clockwise direction by reversely-rotating only the right motor.

In addition, although in the above-mentioned embodiment the inclination of the lenticular sheet is corrected by clamping the lenticular sheet in a state inclined in the anticlockwise direction and rotating the clamper in the clockwise direction, the inclination of the lenticular sheet may be corrected by clamping the lenticular sheet in a state inclined in the clockwise direction and rotating the clamper in the anticlockwise direction. In this case, the clamper is rotated in the anticlockwise direction by forwardly-rotating the right motor at a higher speed than the left motor.

Furthermore, although in above-mentioned embodiment the clamper clamps the lenticular sheet in a state parallel to the main scanning direction and is inclined by the inclination correction, the clamper may clamp the lenticular sheet in a state inclined relative to the main scanning direction and be set parallel to the main scanning direction by the inclination correction.

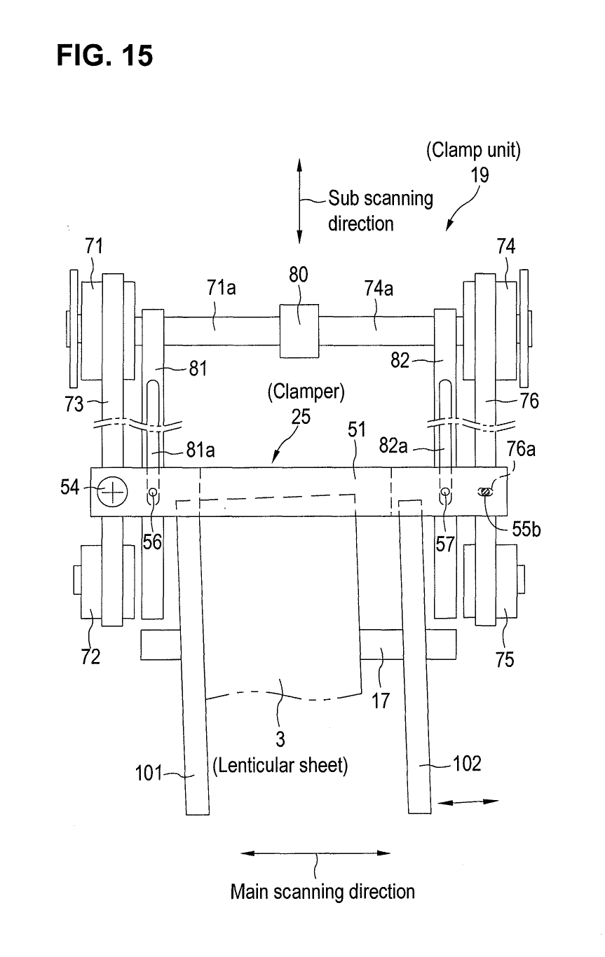

In addition, although in above-mentioned embodiment the lenticular sheet is inclined in the anticlockwise direction by the left receiving pin and the right receiving pin arranged on the clamper, as shown in FIG. 15 a left restricting plate 101 and a right restricting plate 102 inclined in the anticlockwise direction may be arranged instead of the left oblique motion restricting plate and the right oblique motion restricting plate, and the lenticular sheet 3 may be inclined in the anticlockwise direction by these restricting plates 101 and 102. In this case, the left restricting plate 101 is arranged in a rotatable manner, and when the lenticular sheet 3 is rotated in the clockwise manner to perform inclination correction, the left restricting plate is also rotated together in the clockwise direction. In addition, the clamper 25 has no left receiving pin or right receiving pin arranged.

Furthermore, although in above-mentioned embodiment the left motor and the right motor are rotated in the unconnected state when carrying the lenticular sheet, the left and right motors may be rotated in the connected state to carry the lenticular sheet. In this case, since the left and right motors are rotated in a synchronized state, the inclination of the lenticular sheet due to the rotational speed difference between the left and right motors is prevented.

In addition, although in above-mentioned embodiment the clamper opening/closing mechanism is comprised of the springs, the cam shaft, and the clamp releasing motor arranged in the clamper, the clamper and the configuration of its opening/closing mechanism are not limited to above-mentioned ones. For example, the opening/closing actions may be performed in a manner wherein when the clamper has moved to the clamp position, a fixed member press-contacts the movable plate and lifts it up against the bias of the springs to the hold-release position, and when it has moved slightly to the downstream side from the clamp position, the press-contact with the fixed member is released to set it to the hold position, or the opening/closing actions may be operated by a motor for example.

Furthermore, although in above-mentioned embodiment the clamper is moved in the sub scanning direction by motors and belts, instead of being limited to this, a base plate may be arranged which has a lead screw rotated by a carrying motor and a screw aperture combining with the lead screw formed and moves in the sub scanning direction by the rotation of the carrying motor, and the clamper may be attached to the base plate. In this case, the lenticular sheet is rotated by attaching the clamper to the base plate in a rotatable manner and rotating the clamper by a motor for rotation.

In addition, the present invention can be applied to inkjet printers, laser printers and the like.

What is claimed is:

1. A printer comprising:
a holding unit which holds a lenticular sheet having a plurality of lenticular lenses aligned in a constant pitch;
a carrying unit which carries said lenticular sheet by moving said holding unit in the sub scanning direction;
a recording unit which records at least two kinds of images by recording a plurality of striped images parallel to the main scanning direction extending along in the direction perpendicularly crossing said sub scanning direction on the rear face of said lenticular sheet carried by said carrying unit;
a sheet inclining unit which inclines said lenticular sheet in a first direction or in the direction which the longitudinal direction of said lenticular lenses are inclined with respect to said main scanning direction, prior to the holding of the lenticular sheet with said carrying unit;
an inclination angle detecting unit which detects the angle of inclination between the longitudinal direction of said lenticular lenses and said main scanning direction in a state wherein said lenticular sheet is held by said holding unit; and
an inclination correcting unit which corrects the inclination by rotating said holding unit in a second direction which is the opposite direction to said first direction, based on the detected results of said inclination angle detecting unit, so that the longitudinal direction of said lenticular lenses becomes parallel to said main scanning direction.

2. The printer according to claim 1, wherein said carrying unit comprising;
a first belt conveyer having a first belt to which one end in the main scanning direction of said holding unit is attached and a first motor which rotates said first belt, and
a second conveyer having a second belt to which the other end in the main scanning direction of said holding unit is attached and a second motor which rotates said second belt,
wherein said inclination correcting unit rotates said holding unit in said second direction by controlling the driving of at least one of said first motor and said second motor based on the detected results of said inclination angle detecting unit.

3. The printer according to claim 2 comprising:
a clutch mechanism which switches between the connected and unconnected states of said first motor and said second motor,
wherein said clutch mechanism is switched to the unconnected state when rotating said holding unit in said second direction by said inclination correcting unit.

4. The printer according to claim 1 comprising;
a carrying roller which carries said lenticular sheet to said holding unit, and
two plates of oblique motion restricting plate which restrict the oblique motion of said lenticular sheet, wherein the plates are arranged on the both sides of said lenticular sheet carried by said carrying roller.

5. The printer according to claim 2 comprising;
a carrying roller which carries said lenticular sheet to said holding unit, and
two plates of oblique motion restricting plate which restrict the oblique motion of said lenticular sheet, wherein the plates are arranged on the both sides of said lenticular sheet carried by said carrying roller.

6. The printer according to claim 4 comprising;
a sliding mechanism which slides at least one of said two plates of oblique motion restricting plate in said main scanning direction,
wherein said sliding mechanism slides at least one of said oblique motion restricting plates in said main scanning direction to position said lenticular sheet in said main scanning direction prior to the holding of the lenticular sheet with said carrying unit.

7. The printer according to claim 5 comprising;
a sliding mechanism which slides at least one of said two plates of oblique motion restricting plate in said main scanning direction,
wherein said sliding mechanism slides at least one of said oblique motion restricting plates in said main scanning direction to position said lenticular sheet in said main scanning direction prior to the holding of the lenticular sheet with said carrying unit.

8. The printer according to claim 1,
wherein said sheet inclining unit comprising two units of receiving unit arranged on said holding unit so as to receive the front end of said lenticular sheet at different positions in said sub scanning direction.

9. The printer according to claim 2,
wherein said sheet inclining unit comprising two units of receiving unit arranged on said holding unit so as to receive the front end of said lenticular sheet at different positions in said sub scanning direction.

10. The printer according to claim 1,
wherein said sheet inclining unit includes two units of receiving unit arranged on the sheet inclining unit so as to receive the front end of said lenticular sheet at different positions in said sub scanning direction.

11. The printer according to claim 2,
wherein said sheet inclining unit includes two units of receiving unit arranged on the sheet inclining unit so as to receive the front end of said lenticular sheet at different positions in said sub scanning direction.

12. The printer according to claim 11,
wherein said two units of receiving unit are two receiving pins having different diameters.
